(19) United States
(12) Patent Application Publication
(10) Pub. No.: US 2015/0291133 A1
(43) Pub. Date: Oct. 15, 2015

(54) MOBILE SYSTEM FOR REPLACING REMOVABLE FUEL TANKS

(71) Applicant: Erving Javier Hidalgo Balboa, Santiago (CL)

(72) Inventor: Erving Javier Hidalgo Balboa, Santiago (CL)

(21) Appl. No.: 14/403,939

(22) PCT Filed: Feb. 4, 2013
(86) PCT No.: PCT/CL2013/000008

§ 371 Date: Apr. 29, 2015

(30) Foreign Application Priority Data
May 31, 2012 (CL) 1431-2012

(51) Int. Cl. B60S 5/02; B67D 7/04; B60K 15/03

(52) U.S. Cl. CPC B60S 5/02; B60K 15/03; B67D 7/04; B60K 2015/03164; B60K 2015/03184

(57) ABSTRACT

The present patent application relates to a mobile or removable system of fuel tanks for lorries, for example large-size lorries such as those used in the mining industry. The invention specifically relates to a system comprising a tank-carrying device used to transport the empty or full fuel tanks to and from a fuel distribution centre and from the lorries to be supplied with fuel. Said system also comprises a facility arranged in the lorries, that enables the tanks to be removed from the lorries. This facility can be completely new or an adaptation of the anchoring system that lorries currently have for fixing the tanks, on the condition that said anchoring system comprises a mechanism of mobile guides for positioning and removing the tank rapidly. The problem solved by the invention relates to the cost, time and risk involved in the traditional way of loading the fuel into the lorries provided with a fixed tank, especially large-size lorries such as those used in mining. The same concept can also be used for fuel storage tanks for the personal consumption of companies, whether in the town, in rural areas or in areas that are difficult to access. In this way, fuel facilities do not need to be built below or above ground, the current concept being replaced with a removable tank adapted to current fuel distribution tanker lorries, special trailers and tank-carriers, enabling the fuel tanks to be completely removable from the structure of the lorry. The system can be used for transporting both full fuel tanks and empty fuel tanks to be filled in plants or distribution centers.

The present patent application relates to a mobile or removable systems for fuel tanks for trucks, such as large size trucks like those used in the mining industry. Specifically, the invention relates with a system that provides a tank carrier device that operates to carry empty or full fuel tanks from and to a fuel distribution center from and to the trucks to be refill. The system also includes a facility provided in the trucks, the facility allows removing the tanks from the truck. This facility can be completely new or customization of the anchoring trucks currently use to secure the tanks the difference being in that said anchoring is provided with a mechanism of mobile guides to insert and remove the tank in a prompt way. The problem solved by the invention relates to costs, time, and risks involved in the traditional operation followed when filling fuel in trucks having a fixed tank, particularly large size trucks as those used in mining.

The same concept can also be adopted for storage tanks for fuel used by companies in different areas such as the city and rural areas and areas with difficult access. Thus is prevented building surface or underground facilities for fuel storage, replacing the current concept used with a removable tank. This can be applied to current tank trucks used for fuel distribution in special trailers, fuel trucks. Making them removable from the truck. To be transported full or empty, for refill at the plant or distribution centers.

### PREVIOUS ART

At present logistics in fuel supply for haulage trucks in major mining relies upon having fixed tanks, with an approximate investment of USD 3 million (for 600 m3 storage capacity) depending on the size and not including operation and maintenance costs (tank cleaning, painting, re-certifications, pressure tests, etc.). These tanks age fast as the dynamics at the mine site renders the tanks as a supply point far in the short term from the optimum route for the trucks. This increases operational costs. To resolve the above semi-mobile fuel tanks have been developed. These allow approach the fuel supply station to the optimum route of haulage trucks, thus avoiding the increase in operational costs. However, this solution poses constraints as it requires an investment to move the facility and new permitting with the corresponding regulator (Superintendence of Power and Fuel.) That is why these are referred to as semi-mobile facilities. The investment of said facilities is around USD 1 million (for 100 m3 storage capacity). It also includes operational costs, maintenance, and relocation.

Another solution that has been developed is using fuel trucks inside the mine site. Using fuel trucks is a necessary condition even when fixed tanks are used. This solution has the downside of requiring an investment in fuel trucks, an amount around USD 180,000 per truck, in addition to operational costs and staff that at best includes a driver who is also in charge of the fuel supply operation. This alternative also involves that an additional mobile equipment enters the site and that such vehicle will be added to the circuit (haulage trucks) with the corresponding risk of collision and exposure to accidents. Lastly, it should also be considered that given its autonomy (a 20 m3 storage capacity in the best of cases), the journey from the mine site to the primary area of fuel supply will be a constant situation, thus increasing the risk above mentioned.

Additionally, there are other problems surrounding the current method used to supply fuel to haulage trucks. These include the speed when filling the truck's tank, the risk of fuel spillage, risk of fuel splashes in the eyes of the operator, fuel cleaning, fuel traceability, adding fuel additives in a segregated manner, control systems for fuel use, and optimization of stops by partial refill to the trucks. Below is a description and an explanation of the problems:
a) Speed when filling the tank of the trucks. Several solutions have been developed in order to provide a more effective use of the equipment and to reduce the actual times of fueling haulage trucks. These include high volume fueling guns, but these have a significant weight hindering the fueling operation, and which have increased the effective fueling time from 8-10 minutes. This time only includes the effective fueling time once the truck stops and is ready to be safely fueled. The downside of this system is that is necessary to invest in a high flow rate systems which entails replacing the fueling guns and also the whole pumping system at the facilities that are to be adapted (fixed fuel tanks, semi-mobile tanks or fuel trucks). In the case of fixed and semi-mobile facilities, the investment amounts to USD 100,000 per facility approximately, while in the case of fuel trucks the investment is around USD 400,000 per truck.
b) Risk of spillage. Most fuel tank connectors in haulage trucks are damaged and dirty. Therefore when fueling the haulage truck and as the connector is dirty the connector creates a counter-pressure upon the fueling gun, thus causing spillage on the floor. It is estimated that these spillages can be around 50 It of fuel approximately for a mining site with a 20 truck fleet. Also, larger spillage is produced when the operator of the tank in agreement with the operator of the haulage truck decide to go beyond the fueling capacity of the truck. That is, the fueling operation will end once the fuel is returned by the fuel tank inlet of the truck. Therefore both operators are certain that the truck's tank is actually full. These spillages are estimated in 20 It approximately. This action is explained by the lack of confidence the operator of the equipment has toward the fuel level odometer in the haulage truck.
c) Risk of fuel splashing the eyes of the operator. Given the conditions of dirt and exposure affecting the connector in the fuel tank of the truck there is a counter-pressure produced by the fueling gun when fueling the tank that causes a spurt toward the face of the operator. When this type of events occur this jet leads to an incident with time loss for the person as well as temporary blindness. The pressure in the spurting out of the fuel may reach from 7 to 11 psi.
d) Cleaning of fuel. Equipment manufacturers require mining companies comply with certain degree of fuel purity. This variable is regulated under ISO 4406. Under the current operational conditions considering fixed and semi-mobile tanks and fuel tanks, ensuring a certain degree of fuel purity forces making modifications in the fueling facilities. These modifications include investing in a fuel micro-filtering system. The investment for this type of system can amount to USD 1 million approximately in addition to operational costs (filters and other) per facility. Furthermore, having a system as such available does not guarantee that a specific degree of purity will be present at the tip of the fueling gun when fueling the truck. This is due to operational carelessness usually affecting connectors and fueling guns, usually dirty.
e) Traceability of the fuel. It is not possible with current systems to conduct any kind of tracking of a specific batch of fuel neither to know which fuel was fed into which equipment. This to determine possible deficiencies in the quality of the fuel used. Also, a system as the one proposed would allow managing tracking the level of fuel for each mobile tank and accordingly, for each haulage truck. This will allow showing the right moment for fueling, thus maximizing the operation of the haulage truck.
f) Segregated addition of fuel additives. Under current developments and standards is not possible to segregate all types of application of special additives to fuel used in a particular site. The only minimum segregation that can be done is to provide the additive completely to a full fixed tank (a given tank in its entirety). On the contrary, in order to isolate the effects of a specific additive that will be tested at the site needs implementing a concurrent logistics for fuel storage without affecting normal operations at the site. Naturally such a concurrent logistics shall also consider additional fuel trucks to carry the fuel with additives. It is also necessary to provide some kind of identification to the haulage trucks using the fuel with the additive.
g) Control system of fuel used. There are actually systems to control the fuel used which need intervention in the computer on board inside the truck, which causes issues with the warranty and further implementation of intrusive systems in rings or keys. These systems are applied to haulage trucks and tanks—fixed, semi-mobile or fuel trucks. The application of these systems need an initial investment cost of approximately USD 500,000 in the case of an operation with 20 haulage trucks. Additionally, operational costs and maintenance of the system are to be considered. In terms of the operation, the system poses certain complexities in the implementation as haulage trucks need to be intervened (computer). And what is very important is that it addresses the lack of confidence of the operator regarding the actual level of fuel in the tank of the truck.
h) Optimization of stops due to partial fueling to the truck. Current systems to control the fuel used and the communication of said systems to the central control room of the mine do not ensure a specific level of fueling in the truck's tank. Accordingly, every time the truck operator starts the working shift he/she will fuel the truck. This method poses operational downsides as it decreases truck utilization and time is used for fueling instead of hauling material. Actually experience shows that in a normal shift fueling levels range from 300 to 600 It per truck for a storage capacity ranging from 4 to 5 m3. This shows that such a practice is very inefficient.

The previous art does not consider systems as the one described in the invention regarding having a mobile system for fuel tanks, nor a fuel truck that can be replaced. However, a precarious solution can be seen in the Patent application from China CN 201427521Y describing a mobile fuel tank provided with an outlet pipe, a line to the vehicle, and a valve, and where the independent body of the tank is inserted in the lower portion of the vehicle and is provided with a connection in said lower part of the vehicle as to allow free movement of the tank and removal of the tank from the vehicle. However said document does not teach not even in the figures how the interconnection works, how is secured in the vehicle and is not even whether it is associated or not to a system with a tank carrier device, therefore the problem of replacing and fueling the trucks is not solved.

An attempt to try to develop an easier system to fuel a large size truck is taught in the Invention Patent application WO 2008/105723 A1, which discloses a system consisting of a mobile duct to fill the fixed fuel tank of a truck. However, it does not teach that the tank can be removed from the truck chassis nor that is associated to a tank carrier device.

The invention presented herein solves these issues by means of implementing a system of removable fuel tanks in the trucks. The system allows placing and removing the empty tank and replaced said empty tank in situ with a full tank in a minimum time. It follows the same concept of a rack. These racks (mobile tanks full with fuel) are stored in working stations near the critical path followed by haulage trucks. The way these mobile fuel tanks are removed and installed on the haulage truck considers a robotic turntable system consisting of a motor driven wheel that rotates and allows removal of the empty tank and placing of the tank full; a quick assembly using a forklift or any other assembling, capable of lifting the weight of the tank full. To ensure that fuel tanks are installed correctly and safely, the haulage truck is provided with a fixed box where the rack is installed thereof, thus ensuring that the box is provided with all the necessary connections for the fueling system to fuel the haulage truck or by means of a guide allowing an accurate entry of the tank full. Therefore, entering of the rack only requires a high precision assembling mechanism. Installation of said box does not intervene the equipment and it is not necessary to drill any holes nor weld pieces to the chassis. For these the same anchoring were the current fixed tank is clamped in the truck.

Additionally, the system considers the implementation of a distribution center at the site where tanks will be correctly filled with the further cleaning and traceability of the fuel to be used to fill the tanks. This distribution center will eventually be arranged in the fuel reception plant at the port where trailers are usually filled to be then sent to each site. Moving this distribution center to the plants will change the current method of transporting the 30-35 m3 fuel trailers to moving racks in traditional trucks or trains.

The greater advantages that can be obtained from implementing these system are:
1) Reduction in the effective fueling time of the haulage truck in around 40%.
2) As these fuel tanks are small (racks), it is feasible to guarantee a good ISO standard in the purity of the fuel to be used at the point of fueling or at the site as once the fuel is filled in the tank there are no more exposure to the environment. Several stages of transfer of fuel will be prevented, different to the method currently used. This will allow compliance with fuel purity demanded by OEMs as per ISO 4406.
3) Savings in investment costs as traditional fixed or semi-mobile tanks will no longer be necessary. This creates a logistic system that is totally different than the traditional wherein only a central location is required (distribution center) where the fuel is received and transferred into the tanks of trucks using a micro-filtering system under safe conditions and a controlled environment. Then, from this distribution center, loading and unloading systems for each rack need to be provided at each of the different points where is necessary to fuel the trucks. Therefore, it will not be necessary to have fuel tanks, fuel trucks in the critical points of supply but only provides the systems of loading and unloading of racks based on the need of the mine site.
   From this major change in concept a new need arises which is to have an internal distribution center wherein the operational concept is handling and disposal of fuel tanks (racks) and not handling and distribution of bulk fuel as is the method currently in use. This avoids all the risks and issues currently posed by this operation (shrink, controls, tracking, cleaning, etc.). Therefore said center can provide the added value of providing the mine with a fueling optimization service for haulage trucks which translates in providing indications to each equipment about the optimum time for fueling, thus ensuring reducing to zero the unnecessary stops. Also, this center will be able to service truck fueling using removable tanks (of the garbage container type) to be delivered to industrial clients as it has been already mentioned.
   Lastly, this concept can also be adopted for a service station by applying the concept of removable tanks in light and heavy vehicles with the corresponding benefits.
4) High investment in high volume systems will be prevented such as the VR 300 system which costs need to be consider with both the tank and the fuel truck as well as the operational restrictions already described.
5) It saves in operational costs as it will reduced or will decrease the need of operational staff to fuel the haulage trucks to a minimum.
6) It is no longer necessary to clean the fuel tanks. Which will lead to savings and less exposure of workers in this type of operation.
7) There will not be traditional shrinkage currently experienced at the fueling points of trucks.
8) There will not be puddles of fuel spillage due to the poor condition of connectors in fuel trucks and dispensers.
9) The impact on the logistics of fuel transportation from this operation and resulting from adopting fuel racks can be substantial as it could eventually lead to replace the typical 30-35 m3 tank, fuel truck with a truck carrying racks full which will lead to further reducing the risk of transportation in the roads.
10) Use of fuel trucks will be reduced to the minimum thus preventing the risks and costs associated to their use and which include exposure of workers at the mine site, exposure of smaller vehicles at the mine site, problems in the service created due malfunctions of fuel trucks or due to the inability to service mining equipment in several places at the same time.
11) Possibility of adding fuel additives with greater accuracy in the tanks rather than at the source or at the site.
12) Possibility of adding a tele-measuring system, integrated in the dispatch to a truck center, to the mobile tank (or rack) such as dispatch of a mine site. This will avoid the installation costs of the traditional automation system where the truck is always intervened, with the corresponding restrictions thereof. We will now track a rack and not a truck.

### BRIEF DESCRIPTION OF THE DRAWINGS

FIG. 1 illustrates an elevation view of a mobile distribution center from which a forklift removes or places a removable fuel tank.

FIG. 2 illustrates an elevation view showing how the forklift removes or positions a removable fuel tank in the tank carrying device.

FIG. 3 illustrates a plan view of the fuel tank carrier device positioning or removing said tank from a truck to be fueled.

FIG. 4 illustrates a plan view of the fuel tank carrier device removing said tank from a truck to be fueled.

FIG. 5 illustrates a plan view of the fuel tank carrier device positioning said tank in a truck to be fueled.

FIG. 6 illustrates a perspective view of the fuel tank carrier device with details removing said tank from a truck to be fueled.

FIG. 7 illustrates a perspective view of the fuel tank carrier device with details positioning said tank in a truck to be fueled.

FIG. 8 illustrates a perspective view showing the detail of a removable fuel tank.

FIG. 9 illustrates an elevation view of a mobile distribution center from which a forklift removes or places a removable fuel tank from a tank storage center where tanks are filled by a fuel truck.

FIG. 10 illustrates a perspective view showing how the forklift removes or positions a removable fuel tank in a truck to be fueled.

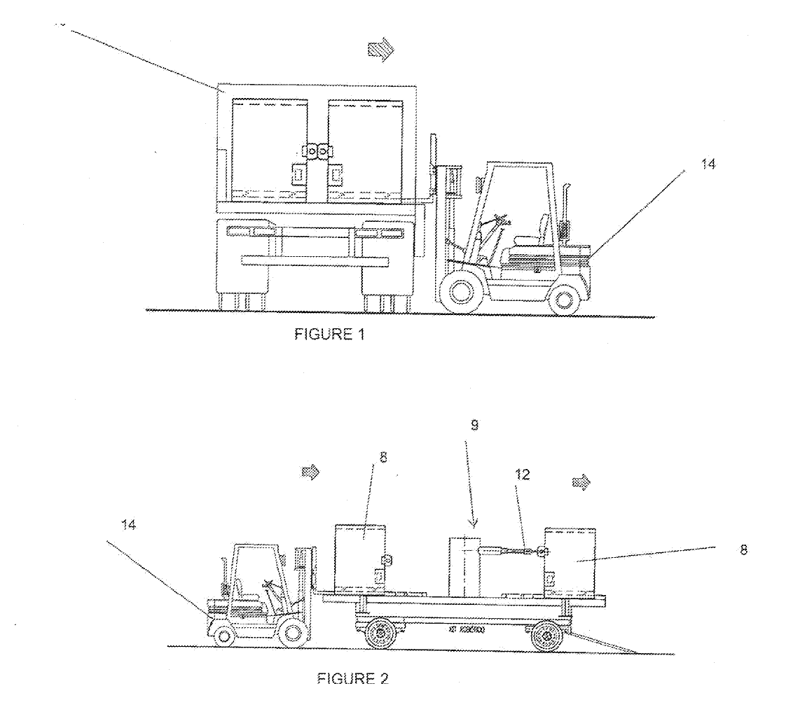

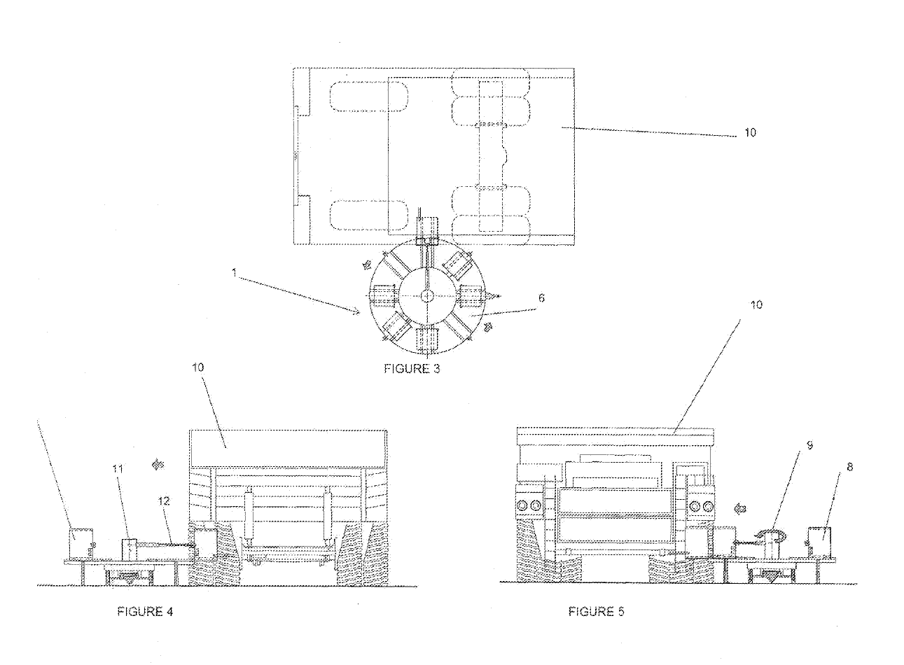

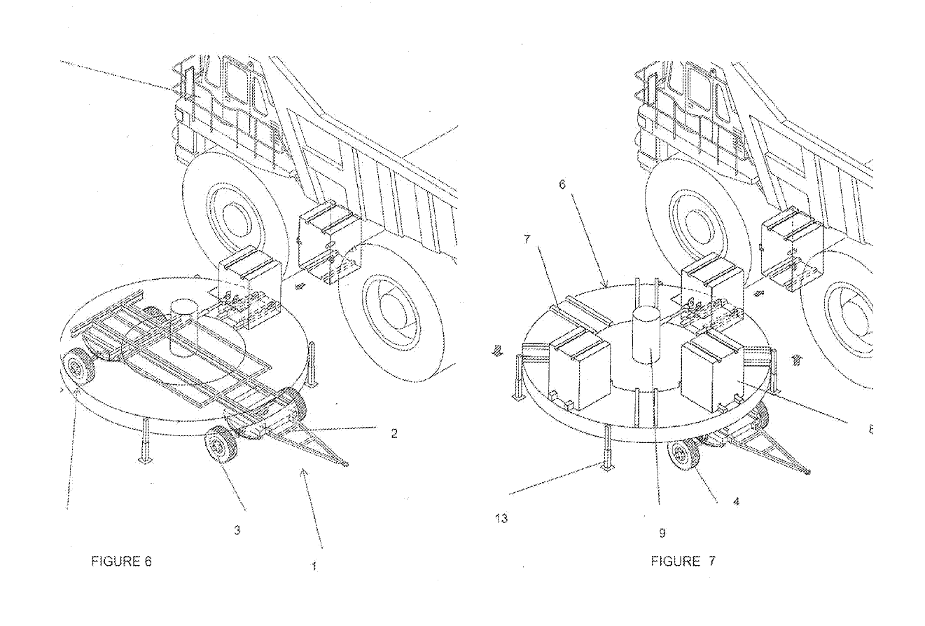

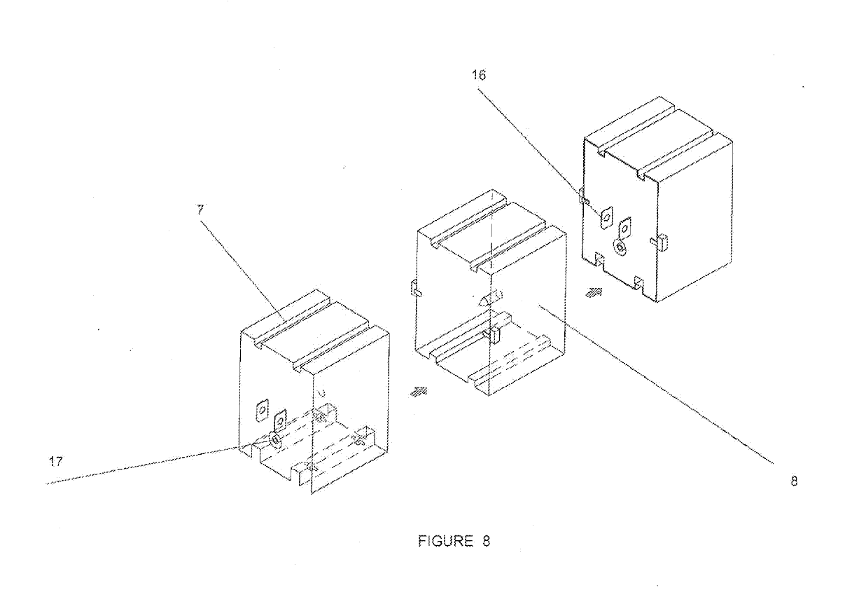

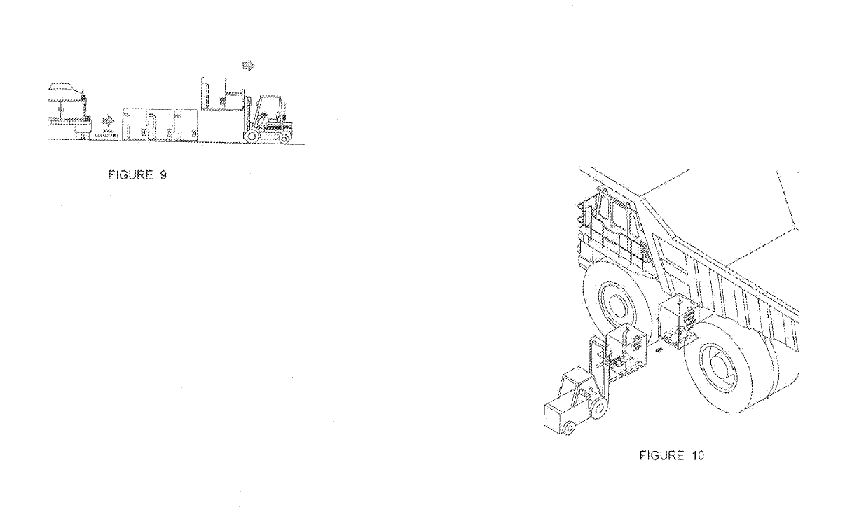

### DETAILED DESCRIPTION OF THE INVENTION

The system of the invention consists of four main elements:
a. A distribution center or fixed or mobile storage area for removable fuel tanks.
b. At least two of said removable fuel tanks.
c. At least two of said removable fuel tanks.
d. An anchoring with guides for said removable tanks, being said anchoring provided in the truck to be fueled.
In a preferred embodiment of the invention the system considers a removable tank unit in the case of fuel trucks delivering fuel to companies. This unit allows delivery of a full tank with all the necessary elements to run said facility in an independent manner. Once certain level of fuel is reached, it is replaced with a different one full. In this embodiment the carrying device considers transporting one single removable tank which is part of the fuel truck with the exception that the tank is completely removed from the truck and will then receive a similar empty to be further filled and to be added again to the circuit.

In a preferred embodiment said carrying device for fuel tanks, both empty and full, is a tank carrier 1 consisting of a structural chassis 2 provided with a means of transportation 3 consisting of at least a front axle 4, a rear axle 5 with wheels that allow the device to roll on any kind of road. Over said structural chassis 2 a turntable system 6 is provided which in its upper end a system of guides 7 is provided, wherein the removable fuel tanks 8 are to be arranged in such a way that a group of tanks arranged over said turntable create a rack of tanks.

On the middle part of said turntable 6 a telescopic device 9 that functions to move the tank from and to the turntable is provided. That is, it inserts the tank full in a specific truck 10 to be fueled and removes the empty tank from said truck. The telescopic device 9 comprises a center of hydraulic storage 11 and a telescopic arm 12 which moves said tank 8 from and to the turntable 6 running on said guides 7.

The turntable 6 is further provided in its external edge with anchoring legs 13 that prevent the chassis 2 from moving when the tanks are being removed or positioned.

Loading and unloading of the tanks 8 can be done in the turntable 6, for example using a forklift 14 which allows carrying said tanks to, for example, a delivering truck 15 and to replace a tank full at the same time. The delivering truck can perfectly become such fixed distribution center provided with the tanks designed for the turntable.

To completely undertake loading and unloading of the tanks 8, the delivering truck with the tanks is provided in its traditional anchoring with the same type of system of guides the turntable 6 has, therefore the telescopic device 9 projects or retracts its arm 12 once the anchoring guides of the truck are aligned with the guide of the turntable 6.

In this way and as it has been already explained before the system allows removing the empty tank and replace it with a tank full in situ in the shortest time possible.

Both the tank 8 and the anchoring provided in the truck carrying the tanks have a means of connection 17 favoring the interface between the fuel that is present in the tank 8 and the line of supply of fuel from the truck 10. At the same time the tanks 8 are provided in one of the lateral sides with a pair of lugs 16 through which the telescopic arm 12 connects and produces the action of movement from and to the turntable and the truck 10.

While not shown in the Figures the system is also provided with means for weighting and measuring of the volume of the tanks 8. It is also provided with sensors that trigger an alarm in the event of a crack or spillage of the tanks arranged over the turntable. Additionally, it is provided with proximity sensors as to help the operator know how close the tank carrying device 1 is from a forklift 14 or a truck or distribution center 15. The tanks 8 are provided with automatic level and traceability sensors therefore it is known at the distribution center bringing the fuel how much was fueled in the tank and in which truck was the fueling done. In every fueling operation an operator will enter the date for traceability purpose and will mark the route to be allocated to that individual tank. Accordingly each tank is provided with a remote communication system with a logistic center where information is managed as well as the statistical information of fueling in trucks is managed.

This makes possible that each tank carrier device 1 to have a determined amount of small tanks which allow a faster and safer movement of the fuel as well as to know in real time the stock of fuel, the number of times the tank is used, and the fuel level remaining inside the tank when is installed in the truck.

Also not shown in the Figures, the anchoring provided in the truck to be fueled is provided with a reserve tank as to make possible for the truck to move regardless the fact that the mobile tank 8 is out of fuel. In this embodiment all fuel connections to feed the truck engine are provided in said reserve tank. Therefore the mobile tank 8 only uses the connection means 17 to bring fuel to the reserve tank.

1. A system of mobile or removable fuel tanks for trucks, wherein said system consists of:
a. a distribution center, or a fixed storage area, or a mobile storage area for removable fuel tanks;
b. at least two of said removable fuel tanks;
c. a device to carry said removable fuel tanks; and
d. an anchoring with guides for said removable fuel tanks, said anchoring provided in the truck to be fueled.

2. The system of mobile or removable fuel tanks for trucks according to claim 1, wherein said device to carry said removable fuel tanks is a tank carrier consisting of a structural chassis provided with a means of transportation consisting of at least a front axle, and a rear axle with wheels that allow the device to roll on any kind of road.

3. The system of mobile or removable fuel tanks for trucks according to claim 2, wherein a turntable system provided with a system of guides in its upper end is positioned on top of said structural chassis, wherein said removable fuel tanks are arranged in a group of tanks on said turntable to create a rack of tanks.

4. The system of mobile or removable fuel tanks for trucks according to claim 2, wherein a telescopic device is centered over said turntable.

5. The system of mobile or removable fuel tanks for trucks according to claim 4, wherein said telescopic device consists of a hydraulic storage center and a telescopic arm.

6. The system of mobile or removable fuel tanks for trucks according to claim 2, wherein said turntable is further provided with anchoring legs on the external edge of the turntable that prevent movement of the chassis.

7. The system of mobile or removable fuel tanks for trucks according to claim 1, wherein said anchoring is provided with system of guides similar to the guides provided in said turntable that cause the arm of said telescopic device to project or retract when the anchoring guides of the truck are aligned with the guide of the turntable.

8. The system of mobile or removable fuel tanks for trucks according to CLAIMS claim 1, wherein both said removable tank and said anchoring have a means of connection that permits the interface between the fuel that is present in the tank and the line of supply of fuel from the truck.

9. The system of mobile or removable fuel tanks for trucks according to claim 1, wherein said system is provided with means for weighing and measuring the volume of said removable fuel tanks.

10. The system of mobile or removable fuel tanks for trucks according to claim 1, wherein said system is provided with sensors located on said turntable that trigger an alarm in case of a breakage or spill from the tanks.

11. The system of mobile or removable fuel tanks for trucks according to claim 1, wherein said system is provided with proximity sensors.

12. The system of mobile or removable fuel tanks for trucks according to claim 1, wherein said tanks are provided with automatic level and traceability sensors.

13. The system of mobile or removable fuel tanks for trucks according to claim 1, wherein each tank is provided with a remote communication system.

14. The system of mobile or removable fuel tanks for trucks according to claim 1, wherein said system can be installed or removed using a forklift or any other means.

15. The system of mobile or removable fuel tanks for trucks according to claim 1, wherein said device to carry said removable fuel tanks considers carrying only one removable tank which is part of the fuel truck.

16. The system of mobile or removable fuel tanks for trucks according to claim 1, wherein said anchoring further comprises a reserve fuel tank that receives fuel from said mobile tank.

17. The system of mobile or removable fuel tanks for trucks according to claim 16, wherein said reserve tank comprises the connections for injection and return of fuel to feed the engine of a truck.

18. The system of mobile or removable fuel tanks for trucks according to claim 1, wherein said truck is a large size truck similar to those used in the mining industry.

19. The system of mobile or removable fuel tanks for trucks according to claim 1, wherein said removable fuel tanks can be either empty or full.
